(19) United States
(12) Patent Application Publication
(10) Pub. No.: US 2025/0155594 A1
(43) Pub. Date: May 15, 2025

(54) SUBSURFACE DATA PROCESSING FOR ENHANCED FRACTURE PROPAGATION MEASUREMENT

(71) Applicant: Halliburton Energy Services, Inc., Houston, TX (US)

(72) Inventors: David Diller, Highlands Ranch, CO (US); Mikko K. Jaaskelainen, Houston, TX (US)

(21) Appl. No.: 18/505,529

(22) Filed: Nov. 9, 2023

(51) Int. Cl. G01V 1/28; E21B 43/26; G01V 1/30

(52) U.S. Cl. CPC G01V 1/282; G01V 1/288; G01V 1/302; G01V 1/40; E21B 2200/20; G01V 2210/614; G01V 2210/646

(57) ABSTRACT

Some implementations relate to a method for determining a seismic event location of a first seismic event, the method comprising: determining an apparent location of the first seismic event based on first sensor information from a first sensing device; substituting first modeled information for the first sensor information; generating second modeled information associated with a second sensing device and a neighboring seismic event; and determining the seismic event location based on the first and second modeled information.

### TECHNICAL FIELD

The disclosure generally relates to seismic analysis within wellbores formed in subsurface formations, and in particular, deploying sensing devices in a wellbore for use with microseismic data processing.

### BACKGROUND

Unconventional reservoirs may be hydraulically fractured in order to allow commercially viable volumes of hydrocarbons to be produced. It may be desirable to access and connect with as much reservoir rock as possible through proper well placement, well completion design, and optimized fracturing operations. Multiple horizontal wells at different depths and reservoir layers may be drilled into one or more subsurface reservoirs, cased, and cemented. Each well is then divided into a number of segments called stages where each stage will have a completion design with a number of pathways connecting the inside of the casing with the subsurface formation. The hydraulic fracturing process is then executed on a stage basis where the first step is to generate pathways into the subsurface formation, normally through perforation charges that blast through the casing and cement layer into the surrounding reservoir rock.

Fracturing operations may be designed to pump a specific amount of fracturing fluid into each stage in a reservoir (or each perforation cluster) with a given well spacing and completion design in order to contact a targeted reservoir volume with the hydraulic fractures. Fracturing operations control fluid flow rates, pressures, chemical composition and proppant concentration during the stage execution. Chemicals may include friction reducers to reduce frictional pressure losses along the casing to allow pumps to operate at lower surface pressure while meeting the subsurface pressures required to fracture the rock. Other chemicals may change viscosity and properties to enable better proppant transport as the frac fluid is pumped through the casing, perforations and into the formation.

General reservoir properties may be understood from seismic surveys, wireline logging runs, core samples etc. These properties may be used to place well bores into the one or more reservoirs and to design fracturing operations. Many reservoirs may have existing wells in the same or proximate reservoir layers where pressure may be locally reduced, and all reservoirs are inhomogeneous to various degrees. Future wells may be placed in areas where reservoir characteristics are more complex as many sweet spots with good reservoir conditions may already be drilled. It is therefore desirable to monitor fracturing operations using microseismic monitoring in order to verify that the generated fractures are being placed per a field development plan given the various uncertainties. One practical and cost effective technology for microseismic monitoring may utilize Distributed Acoustic Sensing (DAS) and one or more fiber optic cables.

Real-time DAS analysis may be used in carbon capture and storage (CCS) where the objective is to inject a desired volume of fluid into selected reservoir layers without damaging the cap-rock layer of the reservoir. It may be desirable to provide real-time monitoring of inflow points and inflow volumes in a completion and reservoir using DAS technology, wherein each inflow zone is monitored in order to determine flow into the zone by analyzing DAS data. A Design of Experiment (DoE) operation during startup, wherein Inflow Control Devices (ICDs) (e.g., an Inflow Control Valve (ICV)) are cycled in a planned manner and combined with various measured data (e.g., surface flow rates and surface and subsurface pressures) to generate a varied data set that may be used to build data-driven flow-allocation models using machine learning methods. Injection pressures may often be limited to a calculated value to keep the reservoir pressure below a fracture gradient at which caprock failure would occur. The injection pressure may be increased with real-time microseismic monitoring as injection pressures may be reduced if any signs of induced microseismic activity is detected. The sensor data and associated models may then be used to control the CO2 injection pressures and rates, as well as ICV setting.

It is a common regulatory requirement to monitor cap-rock integrity where cap-rock failure may be predicted by real-time measurements (e.g., induced microseismic events, surface injection pressure, downhole pressure(s) and strain measurements). Real-time measurements may be used to predict caprock failure and multiple measurements over time will provide higher certainty of the prediction. In certain situations, sensing cables may be permanently installed in the treatment/injection wells and/or monitoring wells. In other implementations. surface 1-axis and/or 3-axis seismic sensors (e.g., geophones or accelerometers) may be used for data collection. Other injection and storage facilities (e.g., natural gas storage caverns or hydrogen storage caverns) may have many challenges similar to CCS injection and storage.

It may be common to inject water or produced fluids into reservoirs for pressure maintenance in order to optimize production, mitigate subsidence, or fluid disposal. Realtime indicators, like induced microseismic event detection, enable improved control of injection pressures, flow rates, and rates of change to avoid formation and caprock damage. The control loop, open or closed, may use microseismic measurements as an input with pressure, rate, and zone ICD settings as control variables.

Enhanced geothermal systems may be intentionally fractured in order to contact a desired rock volume thus enabling thermal energy harvesting. It may be desirable to monitor the fracturing operating in real-time similar to the case of unconventional wells. Production operations in geothermal wells may require a balance between re-injected fluid and produced fluid to prevent fractures from closing. Closing fractures may generate microseismic events as the rock shifts and slips and it is desirable to provide closed loop control between the injection and production based on real-time data obtained from DAS systems for microseismic events, DSS systems for formation strain and movement monitoring, and DTS systems for temperature monitoring. The sensing cables may be installed in the injection and/or production wells. Fiber optic sensing data like temperature, strain, subsurface pressure and microseismic events may be inputs to control injection and production pressures and rates.

### BRIEF DESCRIPTION OF THE DRAWINGS

Implementations of the disclosure may be better understood by referencing the accompanying figures.

FIG. 1 is an illustration depicting an example multi-well system, according to some implementations,

FIG. 2 is a top view diagram depicting processed microseismic data plots, according to some implementations.

FIG. 3 is a side view depicting processed microseismic data plots, according to some implementations.

FIG. 4 is a flowchart depicting a method for determining a location of a microseismic event detected by a single sensor array, according to some implementations.

FIGS. 5A-5C are diagrams depicting microseismic events captured by two sensor arrays, according to some implementations.

FIG. 6 is an illustration depicting three different optical fiber configurations for use in a wellbore, according to some implementations.

FIGS. 7A-7B are schematic diagrams depicting a process of deploying a fiber optic cable into a wellbore via a conveyance vehicle, according to some implementations.

FIG. 8 is a block diagram depicting an example computer, according to some implementations.

FIG. 9 is a flowchart depicting example operations for determining seismic event locations that are detected by only one sensor array, according to some implementations.

FIG. 10 is an illustration of an example hydraulic fracturing operation in a shale formation, according to some implementations.

### DESCRIPTION OF SOME EXAMPLE IMPLEMENTATIONS

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

### Overview

Accurate detection and location of micro seismic events in a three-dimensional (3D) space may typically require data from two or more horizontal arrays in order to triangulate its location. Conventionally, all sensing systems must have accurate time stamps in order to enable accurate triangulation. Accurate time stamps may be provided with properly GPS-synchronized data acquisition systems. There are however instances where the GPS systems break down, lose track, and drift. Some system configurations may be set incorrectly resulting in challenges to accurately process data. This may, to some extent, be mitigated with accurately calibrated high precision internal clocks within the data acquisition system or by the use of external time code generators with high precision internal clocks.

The distance between instrumented wells and other wells is therefore different depending on which well is being fractured. Micro seismic events (also referred to as microseismic events) may vary in magnitude and attenuate with distance, so it is common to detect events across a range of magnitudes. Low magnitude events may only be detected with an array close in proximity to the event location, in some cases. Therefore, many lower magnitude events may only be detected by a single array, in which case it may be challenging to accurately position the seismic event in a 3D space using triangulation, as DAS systems may generally not be configured to uniquely determine the direction of a seismic event, only the arrival time of seismic waves at different locations along a fiber optic sensing cable. In general, about twenty percent of micro seismic events may be detected by two or more fiber optic sensor arrays. These events, once detected by the two or more arrays, may accurately be located in 3D space whereas the remaining eighty percent of events may only be detected by one array. Microseismic events detected by a single array may have a much larger position location uncertainty and, in many cases, are discarded as unusable data. Because many microseismic events are only detected with one DAS sensor array, it may be a challenge to accurately position the event location in a 3D space, as 3D location may require triangulation with two or more DAS sensor arrays. Thus, a method for predicting a time/volume 3D space where future micro seismic events may occur may be useful for triangulating microseismic events even when they are detected by single sensor array. These events, once located, may be utilized in such a way to improve fracture mapping in real time.

### Example Well System

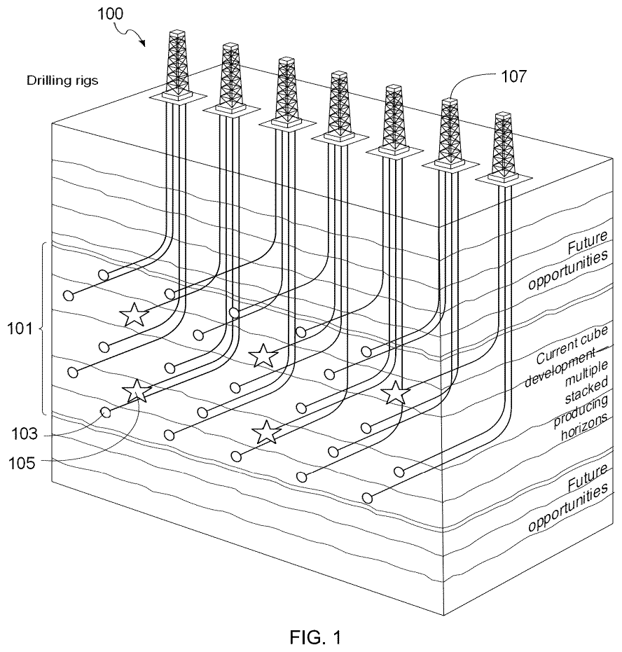

FIG. 1 is an illustration depicting an example multi-well system 100, according to some implementations. The multi-well system 100 may include one or more drilling rigs used 107 each used to drill multiple horizontal wellbores within a subsurface zone 101 at different depths and reservoir layers. In some implementations, the subsurface zone 101 includes various subsurface layers. The subsurface layers may be defined by geological or other properties of the subsurface zone 101. Some of these wellbores within the subsurface zone 101 may be instrumented with sensors while others may not. For example, a treatment well 103 may undergo one or more subsurface operations including hydraulic fracturing, formation stimulation, perforation, etc. Other subsurface applications may include, but are not limited to, hydrocarbon extraction, geothermal energy production, and/or fluid injection (e.g., water or CO2 injection in carbon capture utilization and storage (CCUS) applications).

The treatment well 103 may or may not be instrumented, but an instrumented well 105 may include one or more sensing devices including one or more fiber optic cables, acoustic sensors, geophones etc. used to monitor a treatment operation within the treatment well 103. The one or more optical fibers may be communicatively coupled with one or more computers at the surface to form a distributed acoustic sensing (DAS) system. In some implementations, the instrumented well 105 may be referred to as a monitoring well. Multiple instrumented wells 105 (denoted by stars) may comprise an event monitoring system used to monitor microseismic across multiple wells and well pads. However, one or more additional treatment wells 103, instrumented wells 105, and other well systems may be included. Multiple instrumented wells 105 in a field, reservoir, and/or subsurface zone 101 may be instrumented with optical fibers for monitoring subsurface reservoirs from cradle to grave. In some implementations, the optical fiber(s) may be used to measure fracture growth propagation.

During a hydraulic fracturing operation, treatment well pressure, rate, proppant concentration, diverters, fluids and chemicals may be altered within the treatment well 103 to alter the hydraulic fracturing treatment. These changes may impact formation responses in several different ways, such as changes in strain/stress fields which may generate microseismic effects that may be measured with DAS systems and/or single point seismic sensors like geophones. Fracture growth rates may also change over time, and this may generate changes in measured microseismic events, changes in event distributions over time, changes in measured strain using the low frequency portion, changes in the DAS signal, or changes in Brillouin-based sensing systems. Pressure changes due to poroelastic effects may also be measured by sensors in the instrumented well 105. In some implementations, pressure data may be measured in the treatment well 103 and correlated to formation responses. Various changes in treatment rates and pressure may generate microseismic events that may be correlated to fracture growth rates. Several measurements may be combined to determine adjacent well communication between the well 103 and instrumented well 105, and this information may be used to change the hydraulic fracturing treatment schedule to generate desired outcomes. In some implementations, the treatment well 103 may be a producing well or an injection well. However, the treatment well 103 may also be an oil well, a gas well, a geothermal well, a carbon sequestration well, any other type of injection or production well, etc.

Temperature measurements from e.g. a DTS system may be used to determine locations for water injection applications where fluid inflow in the treatment well (e.g., the treatment well 103), as fluids from the surface are likely to be cooler than temperatures within the subsurface zone 101. Traditionally, DTS warm-back analyses may be used to determine fluid volume placement. This is often done for water injection wells, and the same technique may be used for fracturing fluid placement. Temperature measurements in observation wells such as the instrumented well 105 may be used to determine fluid communication between the treatment well 103 and instrumented well 105, or to determine formation fluid movement.

DAS data such as the data obtained from the instrumented well 105 may be used to determine fluid allocation in real-time as acoustic noise is generated when fluid flows through casing and in through perforations into one or more formations of the subsurface zone 101. These measurements may also be obtained in other areas of the subsurface. Phase and intensity based interferometric sensing systems may be sensitive to temperature and mechanically sensitive to acoustically induced vibrations. DAS data may be converted from time series date to frequency domain data using Fast Fourier Transforms (FFT) and other transforms like wavelet transforms which may also be used to generate different representations of received data. Various frequency ranges may be used for different purposes. For example, low frequency signal changes detected by sensing equipment in the instrumented well 105 may be attributed to formation strain changes, temperature changes due to fluid movement. Other frequency ranges may be indicative of fluid or gas movement. Various filtering techniques and models may be applied to generate indicators of events (e.g., seismic events, microseismic events, formation changes, etc.) that may be of interest. Indicators may include formation movement due to growing natural fractures, formation stress changes during the fracturing operations (this effect may also be referred to as stress shadowing), fluid seepage during fracturing operations, etc. Movement of formations may force fluid into the instrumented well 105, and this may be detected, as well as fluid flow from fractures, as well as fluid and proppant flow from frac hits. Each indicator may have a characteristic signature in terms of frequency content, amplitude, and/or time dependent behavior. These indicators may be present at other data types and not limited to DAS data. Fiber optic cables used with DAS systems may include enhanced back scatter optical fibers where the Rayleigh backscatter may be increased by 10× or more with associated increase in Optical Signal to Noise Ratio (OSNR).

DAS systems such as those disposed in the instrumented well(s) 105 may also be used to detect various seismic events where stress fields and/or growing fracture networks generate microseismic events or where perforation charge events may be used to determine travel times between horizontal wells (e.g., between wells 103, 105). This information may be used from fracture stage to fracture stage to determine changes in travel time as the formation is fractured and filled with fluid and proppant. The DAS systems may also be used with surface seismic sources to generate Vertical Seismic Profiles (VSPs) before, during and after a fracturing job to determine the effectiveness of the fracturing job as well as determine production effectiveness. VSPs and reflection seismic surveys may be used over the life of a well and/or reservoir to track production related depletion and/or track e.g. water/gas/polymer flood fronts.

DSS data may be generated using various approaches and static strain data may be used to determine absolute strain changes over time. Static strain data is often measured using Brillouin based systems or quasi-distributed strain data from FBG based system. Static strain may also be used to determine propped fracture volume by looking at deviations in strain data from a measured strain baseline before fracturing a stage. It may also be possible to determine formation properties like permeability, poroelastic responses and leak off rates based on the change of strain vs time and the rate at which the strain changes over time. Dynamic strain data may be used in real-time to detect fracture growth. In some implementations, the dynamic strain data may be used to detect fracture growth in real-time through an appropriate inversion model. Appropriate actions like dynamic changes to fluid flow rates in the treatment well, addition of diverters or chemicals into the fracturing fluid or changes to proppant concentrations or types may then be used to mitigate detrimental effects.

Fiber Bragg Grating (FBG) based systems may also be used for a number of different measurements. FBG's are partial reflectors that may be used as temperature and strain sensors or may be used to make various interferometric sensors with very high sensitivity. FBG's may be used to make point sensors or quasi-distributed sensors, where these FBG based sensors may be used independently or with other types of fiber optic based sensors. FBG's may manufactured into an optical fiber at a specific wavelength, and other system like DAS, DSS or DTS systems may operate at different wavelengths in the same fiber and measure different parameters simultaneously as the FBG based systems using Wavelength Division Multiplexing (WDM) and/or Time Division Multiplexing (TDM).

### Example Microseismic Data Processing

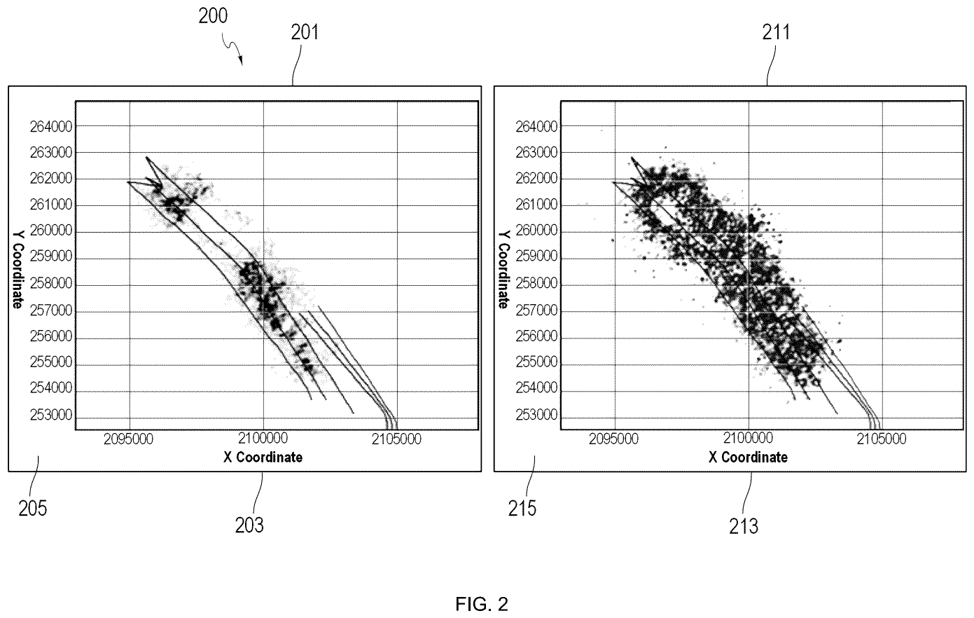

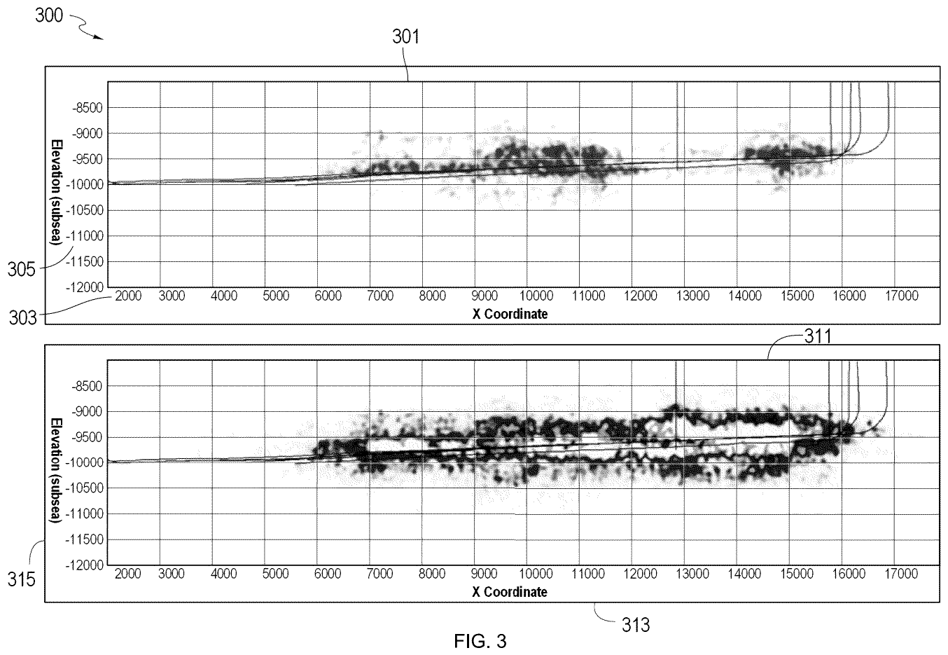

FIGS. 2 and 3 depict top and side profiles of processed microseismic data, respectively. Fracture growth/fracture propagation may occur during a hydraulic fracturing operation while fluid is pumped into a subsurface formation, and also between fracture stages as the formation relaxes and fluids distribute while the formation reach some type of pressure equilibrium. This may induce microseismic events detectable by one or more fiber optic sensor arrays distributed in some wellbores, similar to the instrumented well 105 of FIG. 1.

FIG. 2 is a top view diagram 200 depicting processed microseismic data plots, according to some implementations. A plot 201 may include an X-axis 203 comprising X-coordinates and a Y-axis 205 comprising Y-coordinates. The plot 201 depicts microseismic events detected by two or more fiber optic sensor arrays. The microseismic events depicted in plot 201 were triangulated based on detection by the two or more sensor arrays. A concentration of microseismic events in the X-Y coordinate plane may be determined based on where shading is heaviest (i.e., darker spots have higher concentrations). A plot 211 may include an X-axis 213 comprising X-coordinates, a Y-axis 215 comprising Y-coordinates. The plot 211 depicts the triangulated microseismic events (events detected by two or more sensor arrays) as depicted in plot 211 and additionally depicts microseismic events detected by only a single array. These events detected by a single array may be predicted microseismic events conditionally placed within a simulated 3D time/volume space. These events may be “located” by a second array via modeling despite not being detected by the second array, enabling triangulation of seismic event locations that are detected by one sensor array.

FIG. 3 is a side view 300 depicting processed microseismic data plots, according to some implementations. A plot 301 includes an X-axis 303 comprising X-coordinates and a Y-axis 305 comprising Y-coordinates. The plot 301 shows microseismic events detected by two or more fiber optic sensor arrays, similar to the plot 201 of FIG. 2. A plot 311 includes an X-axis 313 comprising X-coordinates and a Y-axis 315 comprising Y-coordinates. Similar to plot 211, plot 311 shows a significant improvement over conventional practices of only using events triangulated with 2 sensor arrays. Plot 311 shows a larger concentration of microseismic events and is similar to the plot 211 of FIG. 2. Plot 211 depicts both triangulated microseismic events detected by two or more sensor arrays and triangulated microseismic events as determined via one sensor array and via a predicted response at a second sensor array.

### First Example Flowchart of Operations

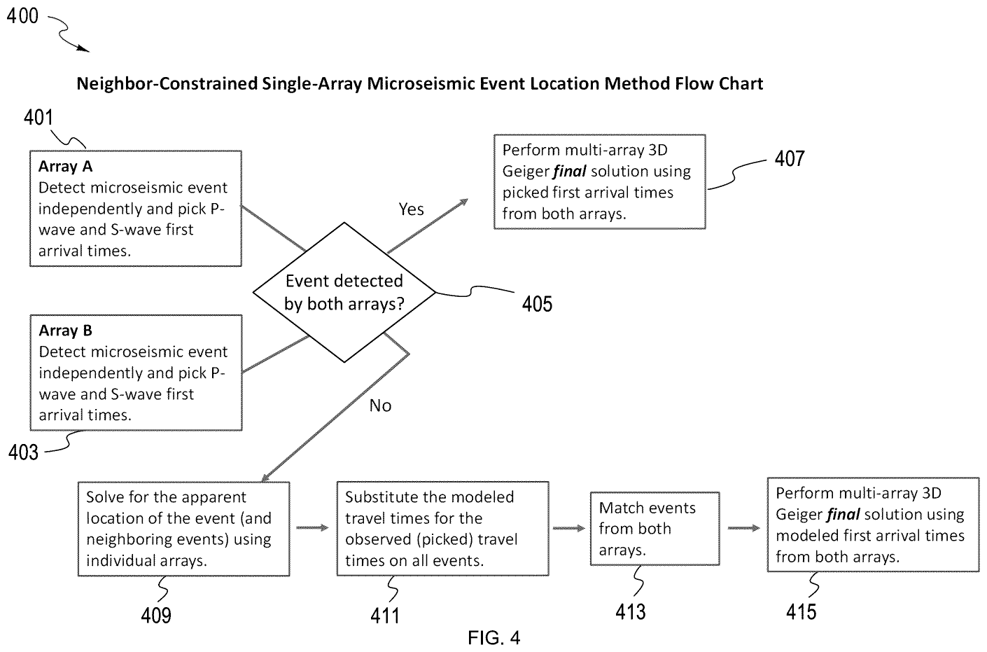

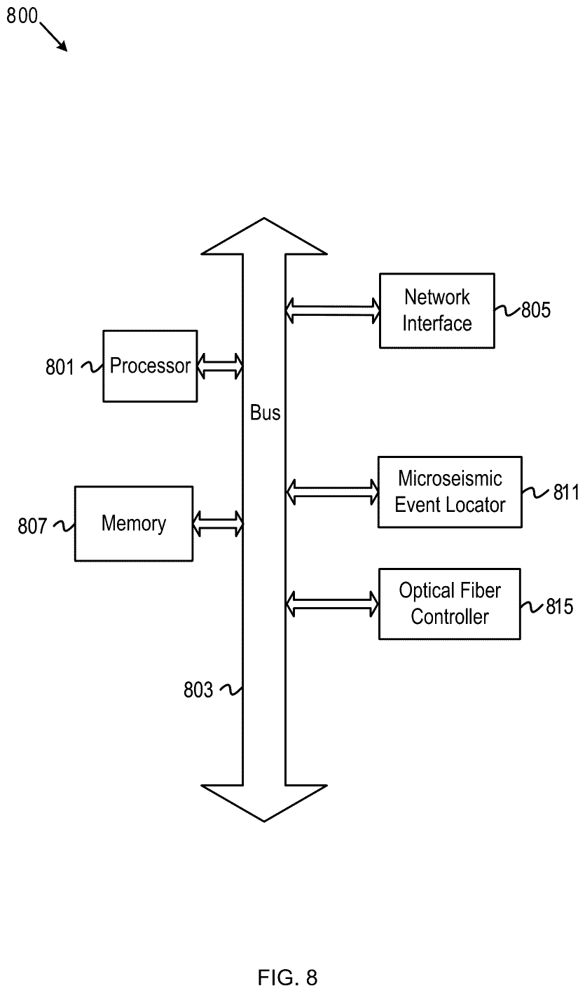

FIG. 4 is a flowchart depicting a method 400 for determining a location of a microseismic event detected by a single sensor array, according to some implementations. Operations of the method 400 may be performed by software, firmware, hardware, or any combination thereof. In some implementations, a microseismic event locator (such as the microseismic event locator 811 described with reference to FIG. 8) may perform the operations of the method 400. Such operations are described with reference to FIGS. 1-3. However, such operations may be performed by other systems or components. The operations of the method 400 begin at block 401.

At block 401, the method includes independently detecting, via a first array, a first microseismic event and pick P-wave and S-wave arrival times. In some implementations, picking may refer to the measurement of arrival times of the P-wave and S-wave seismic phases which may be used to estimate the location of a source event. Flow progresses to block 403.

At block 403, the method includes independently detecting, via a second array, a microseismic event and pick P-wave and S-wave arrival times. This may be similar to the detection process of block 401. The events of blocks 401, 403 may be detected by sensing devices including DAS systems, other optical fiber systems, geophones, acoustic sensors, etc. Flow progresses to block 405.

At block 405, a decision is made depending on whether the microseismic event is detected by both of the sensor arrays of blocks 401 and 403. If the microseismic event is detected by both the first and second arrays, flow progresses to block 407. If the microseismic event is not detected by both the first and second arrays (and is instead detected by a single sensor array), flow progresses to block 409. The method of block 409 and those following may be used to solve for the location of microseismic events detected by only one sensor array. Assuming both arrays of blocks 401 and 403 detected the microseismic event, flow progresses to block 407.

At block 407, the method includes performing a multi-array 3D final solution using the picked first arrival times from both the first and second arrays. In some implementations, this solution may be a multi-array 3D Geiger final solution, although other solutions may be possible via other locating methods. The multi-array 3D Geiger final solution may refer to solving for the location of a microseismic event via Geiger's method. Geiger's method may be used to minimize residuals between observed and predicted arrival times using successive linear approximations. In some implementations, the Geiger solution may also utilize Gauss-Newton optimization to determine the event location. The event location and travel time may comprise the minimum total residual. The uncertainty may be subsequently evaluated at the final location solution using Gaussian statistics. Flow of the method for solving microseismic events detected by two or more sensor arrays ceases. The method for solving event locations detected by a single sensor array is now described. Flow returns to block 405 and continues to block 409.

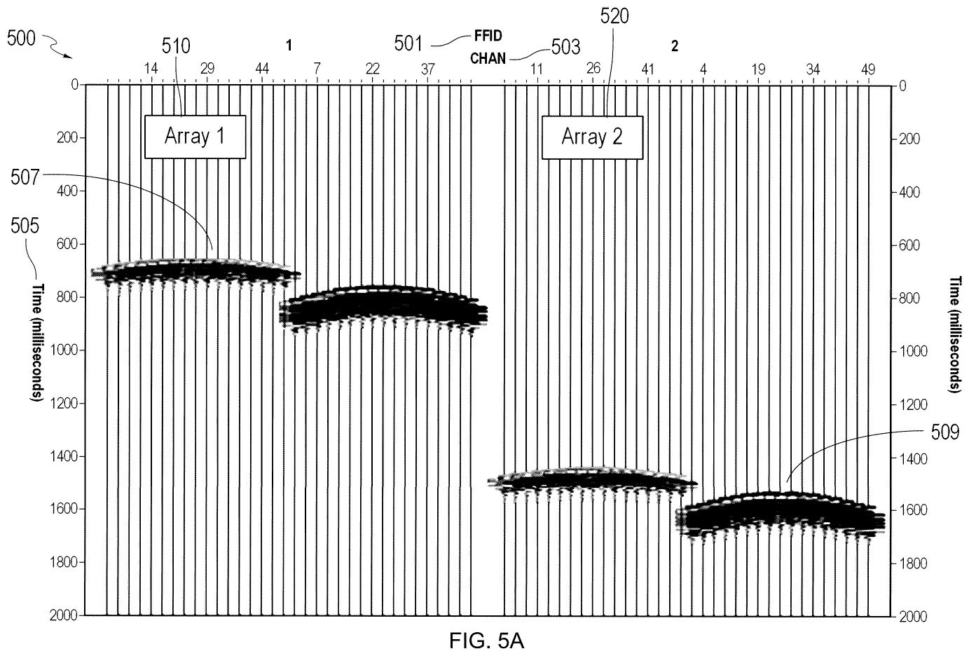

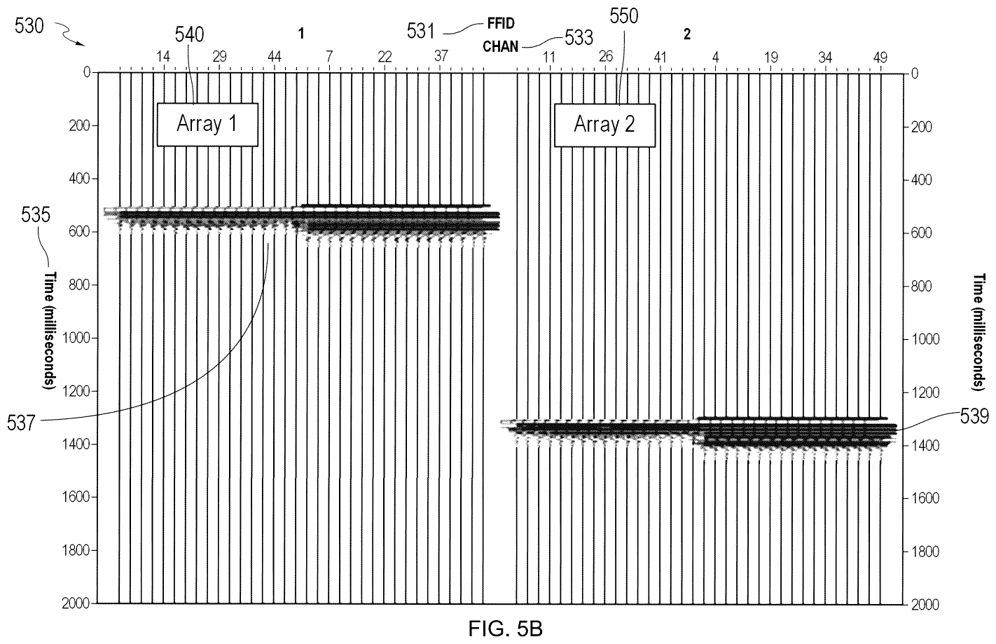

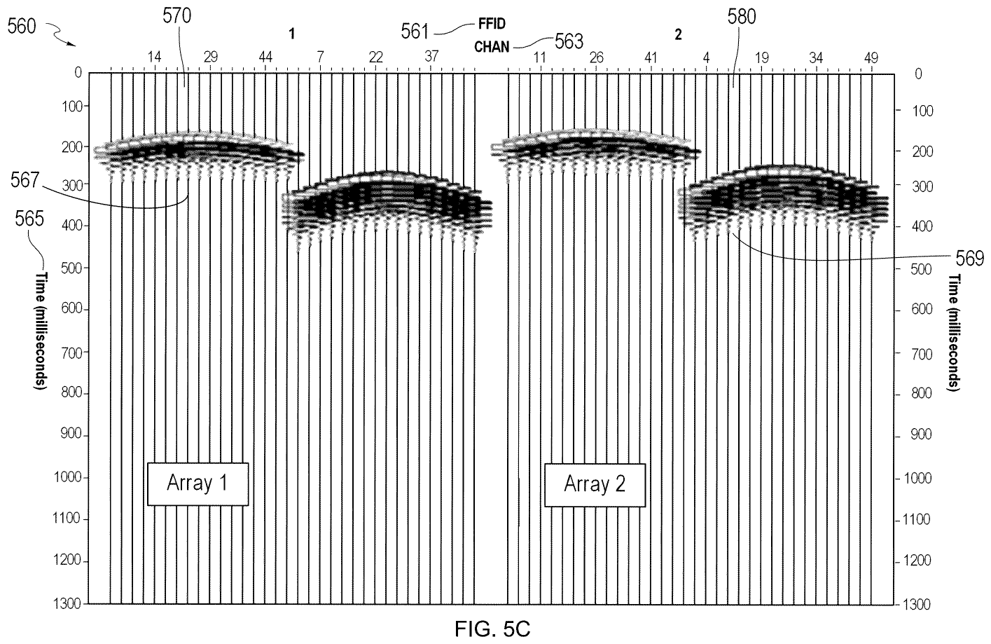

At block 409, the method includes solving for the apparent location of the microseismic event (and neighboring events) using individual arrays. An example of this method of rectifying event locations (and travel times) between sensor arrays is presented in FIGS. 5A-5C. FIGS. 5A-5C are diagrams depicting microseismic events captured by two sensor arrays, according to some implementations. While the process described in FIGS. 5A-5C may be used to remedy a time synchronization problem between sensor arrays, similar logic may be used to simulate observed events on a second sensor array, despite the second sensor array having not detected the microseismic event.

FIG. 5A is a first diagram depicting microseismic events captured by two sensor arrays, according to some implementations. A plot 500 includes a first X-axis 501 of a Field File Identification (FFID) number, and a second X-axis 503 of channel numbers CHAN). The plot 500 also includes a Y-axis 505 of a time in milliseconds (ms). A first array 510 (“Array 1”) includes observed P-waves and S-waves of a microseismic event 507, and a second array 520 (“Array 2”) includes observed P-waves and S-waves of a microseismic event 509. The observed microseismic events 507 and 509 may describe the same event, but the arrays 510, 520 are receiving the event at different times. There is a timing sync problem of the observed microseismic events 507, 509 between the arrays 510, 520. In some implementations, the array 510 may be positioned within a first well, and the array 520 may be positioned within a second well (e.g., instrumented well(s) 105).

FIG. 5B is a second diagram depicting microseismic events captured by two sensor arrays, according to some implementations. A plot 530 includes a first X-axis 531 of a Field File Identification (FFID) number, and a second X-axis 533 of channel numbers CHAN). The plot 530 also includes a Y-axis 535 of a time in milliseconds (ms). A first array 540 (“Array 1”) includes observed microseismic events 537, and a second array 550 (“Array 2”) includes observed microseismic events 539. These observed microseismic events 537, 539 and arrays 540, 550 may be similar to the observed microseismic events 507, 509, and arrays 510, 520 of FIG. 5A. To solve the timing sync problem of FIG. 5A, an apparent location of each microseismic event of the observed microseismic events 537, 539 may be solved for each of the arrays 540, 550 independently. This may result in “flattened” events with more concentrated travel times, and thus, unique solutions of estimated location(s) of where the events may have occurred in the subsurface.

With reference to FIG. 4, a similar approach may be taken in solving for the apparent location of a microseismic event detected by a single sensor array. In some implementations, certain subsurface detection systems (such as geophones) may have a directional component used in determining a direction of received seismic signals. DAS systems such as those disposed in the instrumented well(s) 105 may also be used to detect various seismic events where stress fields and/or growing fracture networks generate microseismic events or where perforation charge events may be used to determine travel times between horizontal wells (e.g., between wells 103, 105). This information may be used from fracture stage to fracture stage to determine changes in travel time as the formation is fractured and filled with fluid and proppant. The DAS systems may also be used with surface seismic sources to generate Vertical Seismic Profiles (VSPs) before, during and after a fracturing job to determine the effectiveness of the fracturing job as well as determine production effectiveness. VSPs and reflection seismic surveys may be used over the life of a well and/or reservoir to track production related depletion and/or track e.g. water/gas/polymer flood fronts. The VSPs may also be useful in generating a-priori data for use in subsurface modeling.

In some implementations, the DAS systems, such as those used in the instrumented well(s) 105, may have not include a directional vector for received seismic events, and the location solution of seismic events detected by a single sensor array may be represented by a ring with a radius extending from the sensor array based on the picked travel times. This ring may include a large number of potential solutions. In some implementations, this radius may also be the radius of a sphere, where the true location of the seismic event lies on or near the surface of the sphere. In some implementations, the radius may be referred to as a distance-to-event radius based on the picked travel times. In other implementations, the estimated solution set for the location of the microseismic event may resemble a cloud of potential sites within the subsurface zone 101.

Three-dimensional (3D) modeling within a 3D model of the subsurface may be used to pinpoint the apparent location of the microseismic event which may have, for example, been detected by the array of block 401 and undetected by array of block 403. In some implementations, a heterogenous layer-cake 3D subsurface model may be used, although other subsurface and/or layered earth models and configurations may be possible. Wave propagation properties such as velocity anisotropy may be known and modeled by individual formation layers. In some implementations, the heterogeneous-anisotropic subsurface may include horizontal layers. In other implementations, the subsurface model may account for dipping of formation layers. Formation layer properties such as their height and lithology may also be known and modeled. For example, the subsurface model may include physical properties similar to the layers of the subsurface zone 101. In some implementations, the formation layers may have vertical transverse isotropy (VTI), tilted transverse isotropy (TTI), horizontal traverse isotropy (HTI), orthorhombic acoustic anisotropy, etc. In some implementations, the a-priori formation information via well logs, analog wells, previous hydraulic fracturing operations, etc. may be used to simulate the formation layers used in the 3D subsurface model. For example, knowledge of regional stress orientation, a dominant fracture plane orientation, and dominant lithologies may be used to constrain potential event locations. Acoustic velocities of simulated P-waves and S-waves may change with the direction of wave propagation. The inclusion of anisotropy in the formation layers may aid in constraining the location of seismic events, providing greater certainty of the event locations.

In some implementations, simulated wave patterns (e.g., via ray tracing or similar methods) may be used to estimate a more precise event location of a seismic event within the 3D subsurface model from an estimated solution area (ring, sphere, cloud, grid or any other suitable area), the solution area determined by picked P and S-wave arrival times of event 507. In some implementations, the solution area may be bounded at operator discretion. In some implementations, DAS systems used in the instrumented wells 105 may be used to obtain P-wave and S-wave velocity profiles via one or more inversions of received data. These velocity profiles may be factored into the 3D subsurface model. In some implementations, the velocity profiles may be used to determine P-wave and S-wave velocities of the events 507, 509.

In some implementations, a subsurface zone of interest within the 3D subsurface model may be divided into a grid of nodes with a range of spatial locations and depths, commonly referred to as voxels. The subsurface zone of interest may be used to locate the apparent location of the event 507. For each voxel, modeled travel times for P-waves and S-waves from that voxel to reach each receiver are computed based on the available velocity model. The modeled travel times are then compared to observed travel times, and the difference is expressed as a residual. In some implementations, the residual may be the root mean square (RMS) or mean absolute value of the differences for all receivers. After testing and considering, potentially thousands, of source-locations, the voxel with the lowest residual represents the closest estimate of the apparent location of the seismic event. In some implementations, a computer, such as the computer described in FIG. 8, may make this determination. For greater location event accuracy, the residual values between voxels may be interpolated.

In some implementations, a plurality of vectors (e.g., rays) may be emitted either from the location of the sensor array 510 and/or from each of the plurality of voxels. The rays may be emitted at the determined P-wave and S-wave velocities. P-wave, single S-wave or multiple S-wave modes resulting from shear wave splitting may be modeled by the 3D subsurface model. In some implementations, the rays may be emitted from any subsurface location within the 3D model to the Arrays 510, 520. The rays may travel through various formation layers of the subsurface zone 101, each with unique acoustic properties that may alter the travel time of each modeled wave. In some implementations, the apparent location of the event 507 may be one or more estimated location areas. In addition to the above, a combination of first and direct arrivals may be utilized, as well as reflections, further constraining the apparent location of the event 507.

In other implementations, a probability density function may be used to further constrain the potential solutions for the location of the event 507. For example, theoretical travel times modeled via ray tracing through the layer cake 3D subsurface model may be used to determine a number of potential event locations within a 3D grid of the subsurface model. For each grid point, theoretical travel times may be compared to observed (picked) travel times such as event 507. The grid location having a maximum of the probability density function (PDF) based on travel time residuals may correspond to the most probable event location.

Continuing the above example in FIG. 5A, the sensor array 520 may not have detected the event 507. However, the sensor array 520 may have detected a separate event (event 509) shortly after the sensor array 510 detected event 507, where event 509 was undetected by the array 510. Event 509 may be considered a neighboring event, where “neighboring” refers to a seismic event that is detected in close time proximity to a first event (event 507). The neighboring event may be the closest event in time to a primary event of interest, although other events and travel times may be selected as the neighbor. In some implementations, a neighboring event may refer to a microseismic event detected by a second sensor array (Array 520) within 5 minutes of a microseismic event detected by a first array (Array 510), although other time ranges may be used to define events as neighbors.

In some implementations, the apparent location(s) of neighboring events such as the event 509 may also be determined via modeling, similar to event 507. For example, an apparent location of event 509 may be determined by generating modeled information for the event 509. In some implementations, the modeling may include determining the location of the event 509 via ray tracing through a heterogenous layer cake 3D subsurface model. Because two or more neighboring microseismic events may likely occur due to similar subsurface changes (e.g., from fractures within a specific stage or wing), it may be assumed that neighboring microseismic events are coming from essentially the same source location. Thus, neighboring events may be used to constrain the location of microseismic events that are only detected by one sensor array-either the array 510 or the array 520. The apparent locations of events 507, 509 may be solved for independently through modeling using the observed travel times detected by the sensor arrays 510 and 520, respectively.

The predictions of the events 507, 509 detected by single sensor arrays (either array 510 or 520) may be based on one or more properties including, but not limited to move out patterns (particularly P-wave/S-wave separation), pump fluid volumes of a fracturing operation, pumped fluid rates, modeled fracture properties (such as azimuth, length, height, width, rates, etc.), and measured fracture properties (azimuth, length, height, width, rates, etc.). The predictions may also be based on measured data from previous jobs and/or previous stages where the prediction is based on data driven approaches like machine learning, deep learning, neural networks, supervised learning, unsupervised learning, etc. Further, the predictions may also be based on measured data in real time (from a current job) where the prediction is based on data driven approaches like machine learning, deep learning, neural networks, supervised learning, unsupervised learning, etc. Flow progresses to block 411.

At block 411, the method includes substituting modeled travel times for the observed (picked) travel times for all events. For example, with reference to FIGS. 5B-5C, the events 537, 539 in FIG. 4B may be replaced by events 567, 569 in FIG. 5C which include modeled travel times. The modeled travel times may be the simulated P and S wave arrival times that best match the picked travel times of events 507, 509. Neighboring events such as event 509 may be used to constrain the apparent location of event 507. In some implementations, observed travel times may be used for the array that actually detected the event (i.e., event 507 detected by array 510), and other arrays may include modeled travel times of other microseismic events that are reasonably close in time. Flow progresses to block 413.

At block 413, the method includes matching events from both arrays 570 and 580. For example, a microseismic event 569 may be matched to a microseismic event 567, both of which include modeled travel times determined via the above-mentioned 3D subsurface model. The matching of events involves determining microseismic events at two different arrays that are reasonably close in time (within a few minutes of one another) that may or may not represent the same actual event. In some implementations, matching of events may occur across a plurality of arrays. The substitution of modeled arrival times and the subsequent matching of events is depicted in FIG. 5C. FIG. 5C is a third diagram depicting microseismic events captured by two sensor arrays, according to some implementations. A plot 560 includes a first X-axis 561 of a Field File Identification (FFID) number, and a second X-axis 563 of channel numbers CHAN). The plot 560 also includes a Y-axis 565 of a time in milliseconds (ms). A first array 570 (“Array 1”) includes event 567, and a second array 580 (“Array 2”) includes event 569. In contrast to events 507, 509, the events 567 and 569 are represented by modeled travel times. By replacing the observed travel times of FIG. 5A with modeled travel times based on apparent locations of seismic events, the difference in starting times (t0) is removed, thereby remedying a synchronization between the arrays 570, 580. This same logic may apply to remedying time differences between mutually exclusive event detections between arrays, enabling triangulation of true seismic event locations.

Matching events 567 and 569 may involve matching the identities of their respective microseismic events across the arrays. Once matched, the events are assumed to be from the same actual event that occurred in the subsurface. Thus, matching the events 567, 569 may aid in constraining the true location of the microseismic event. The matching may use modeled travel times from the event 567 (modeling the original, detected event 507) and modeled travel times from the neighboring event 569. Then the observed travel times (events 507, 509) and modeled travel times (events 567, 569) are combined, and an apparent event location is determined.

Additionally, because two sensor arrays (Arrays 570 and 580) have “detected” microseismic event from essentially the same location, the true location of the microseismic event that generated the events 567, 569 may be triangulated. The substitution of modeled travel times for picked travel times (block 411) and subsequent matching of events with modeled travel times between sensor arrays (block 413) may be performed across a plurality of sensor arrays and/or microseismic events to generate multiple solutions (as seen by the intensified heat maps of FIGS. 2-3). Flow progresses to block 415.

At block 415, the method includes performing a multi-array 3D Geiger final solution using modeled first arrival times from both arrays. The multi-array 3D Geiger final solution may generate a joint solution using modeled travel times from arrays 470, 480 to locate a source location of the event. For example, the multi-array Geiger final solution may determine the true location of the event 507 within the subsurface and an error associated with the determination. Flow of the method 400 ceases.

The multi-array 3D Geiger final solution of block 415 may enable faster and more accurate identification of trends like fracture growth rates, fracture azimuth, fracture complexity, etc. which may enable better predictions of when well interference events may occur and what reservoir volumes may be contacted for a given stage execution. 3D volumes and heat maps of microseismic activity, similar to FIGS. 2-3, may be used to identify reservoir areas that may be unproductive unless changes in real-time stage execution are implemented. The 3D Geiger final solution may be used, alone or in combination with other 3D Geiger solutions from other events, to adjust a subsurface operation. In some implementations, the method 400 may include conditionally placing and collocating events within the 3D subsurface model to generate enhanced microseismic data. The enhanced microseismic data may be used to adjust subsurface operations and associated properties such as injection schedules, proppant concentrations, etc.

In some implementations, real-time data processing of microseismic data may be required to enable a closed-loop control system in hydraulic fracturing. The method described in blocks 401-405 and 409-415 may enable real time processing of microseismic events with higher fidelity than existing technologies and monitoring of fracture evolution in a reservoir over time during hydraulic fracturing operations. The real-time processing and knowledge of fracture evolution (e.g., length, height, width, azimuth, and associated growth rates including changes to growth rates) may enable real-time control of fracturing operations. Real-time control of a fracturing operation may include controlling the fracture equipment to manage injection rates, pressures, chemicals, proppant concentration to achieve certain objectives (e.g., avoiding or controlling well interference where fractures from the treatment well connect with other existing well bores). Real time microseismic data and other real-time data (e.g., strain-based and pressure-based data streams) may be combined to reduce uncertainty and be used as input for controlling the fracturing operation. The enhanced microseismic data determined from FIG. 4 may alternatively/additionally enable changes on future stages/completion designs on the same well or other wells. Completion design changes may include stage length, number of perf clusters, number of per shots per cluster, flow rate per cluster which will impact frac spread controls and frac spread execution. Other change may include changes to chemical composition, fluid volumes, proppant concentration, liquid/proppant ratios etc. The changes may be automatically implemented based in sensed responses in the monitoring wells or treatment wells. In some implementations, a computer (described with additional detail in FIG. 8) may implement these changes.

### Example Optical Fiber Systems

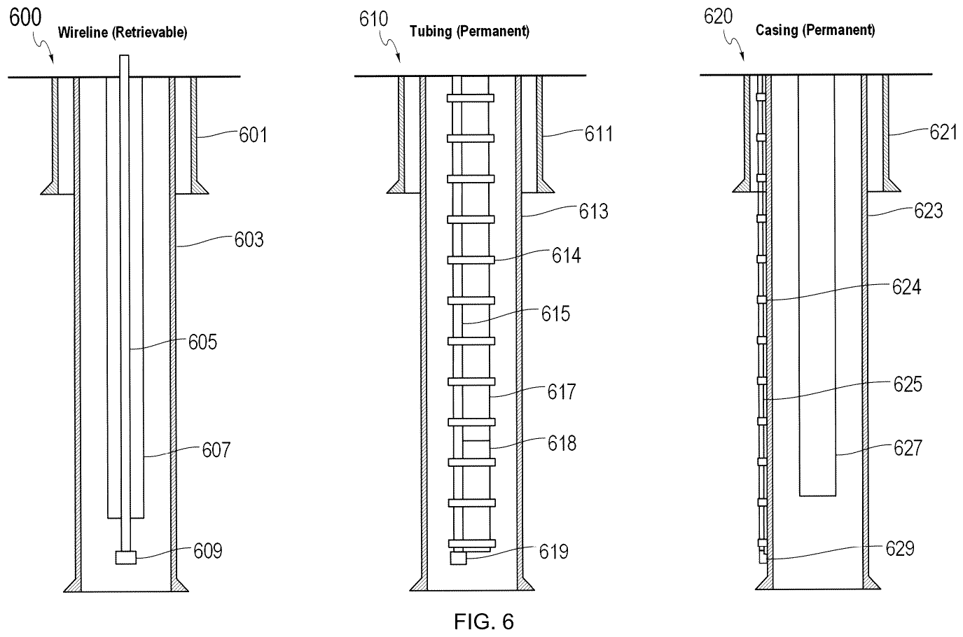

FIG. 6 is an illustration depicting three different optical fiber configurations for use in a wellbore, according to some implementations. Systems 600, 610, and 620 may be used in an illustrative subsurface environment in accordance with some implementations of the present disclosure.

Fiber optic sensing may be used for various sensing applications in the oil & gas industry. There are several ways to deploy fiber optic sensors, and the systems 600, 610, and 620 depict three example configurations used in deploying fiber optic sensing cables in wells. A wireline-conveyed fiber optic sensor system 600 may include a surface casing 601, a production casing 603, a fiber optic cable 605, a tubing 607, and a bottom hole gauge carrier 609. In some implementations, the bottom hole gauge carrier 609 may include a pressure/temperature (PT) gauge.

Optical sensing fibers such as the fiber optic cable 605 may be permanently installed in a treatment well or a monitoring well or deployed using retrievable or disposable technology in a monitoring well. For example, the fiber optic cable 605 and bottom hole gauge carrier 609 may be conveyed and retrieved through the tubing 607 via wireline, slickline, and other conveyance mediums. In other implementations, permanently emplaced systems may be used.

A tubing-mounted fiber optic sensor system 610 may include a surface casing 611, a production casing 613, one or more cross-coupling protectors 614, a fiber optic cable 615, a tubing 617, a tubing tail 618, and a bottom hole gauge carrier 619. In some implementations, the bottom hole gauge carrier 619 may include a pressure/temperature (PT) gauge. The one or more cross-coupling protectors 614 may be included on every other joint of the tubing 617. In some implementations, the tubing tail 618 may extend below a bottom perforation in the well. The fiber optic cable 615 may be mounted to an exterior of the tubing 617. In some implementations, the fiber optic cable 615 may be mounted on the interior of the tubing 617. In some implementations, the fiber optic cable 615 may be mounted internally or externally on coiled tubing.

A casing-mounted fiber optic sensor system 620 may include a surface casing 621, a production casing 623, one or more cross-coupling protectors 624, a fiber optic cable 625, a tubing 627, and a bottom hole gauge carrier 629. In some implementations, the bottom hole gauge carrier 629 may include a pressure/temperature (PT) gauge. The one or more cross-coupling protectors 624 may be included on every other joint of the tubing 627.

Permanently installed sensors may include the fiber optic cables 615, 625. The fiber optic cable 625 may be cemented in place in the annular space between the production casing 623 and a subsurface formation. The fiber optic cable 625 may be clamped to the outside of the production casing 623 during deployment, and the fiber optic cable 625 may be protected by the one or more cross-coupling protectors 624, one or more centralizers, or one or more cross coupling clamps during Run-In-Hole (RIH).

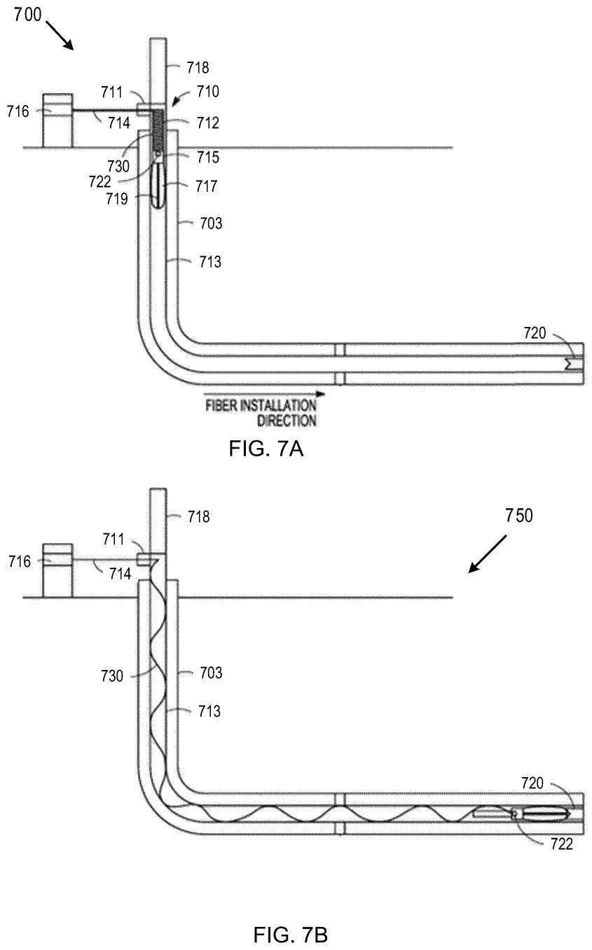

In some implementations, the fiber optic cables 605, 615, and 625 of FIG. 6 may be deployed in wells using gravity where a weight or conveyance vehicle is dropped into a wellbore. An optical fiber may be released in the well as the deployment vehicle moves down the wellbore. The optical fiber may be unreeled out from the surface or from a coil in the deployment vehicle. In some implementations, the conveyance vehicle may be a gravity based deployment vehicle. In other implementations, the conveyance vehicle may be pumped into a horizontal wellbore. One such conveyance vehicle is depicted in FIGS. 7A-7B. FIGS. 7A-7B are schematic diagrams depicting a process of deploying a fiber optic cable into a wellbore via a conveyance vehicle, according to some implementations.

FIG. 7A is a schematic representation depicting an example of pump down spooler insertion, according to some implementations. An optical fiber cable 730 may be installed in a well 703 using pump down installation in a from-top-to-bottom installation process in a production string 713. In some implementations, the well 603 may be a cased hole. Such a method may be employed without the use of coiled tubing equipment for deployment. In various implementations, a fiber spooler mechanism 710 may be used to spool fiber as a conveyance vehicle 700 extends through the well 703. In some implementations, the optical fiber 730 may be pumped down the well 703 from the surface via the conveyance vehicle 700. The conveyance vehicle 700 may lay the optical fiber cable 730 as it goes through the well. The well 703 may be open to a formation at the distal end of the well 703 in order to enable fluid to flow out of the well 703 as the conveyance vehicle 700 is pumped down.

The fiber spooler 710 may include a mud motor 715, a fiber spool 712 containing the optical fiber cable 730 to be laid, and a neutral buoyancy float 717. In some implementations, the neutral buoyancy float 717 may be made of syntactic foam with a density calculated to provide neutral buoyancy of the entire fiber spooler mechanism 710. Thus, it should neither float nor sink in pumping fluid used to pump the fiber spooler 710 towards the end of the well 703. When a pump down fluid is stationary, so too is the fiber spooler mechanism 710. This ensures that no additional strain is applied by gravity to the optical fiber cable 730 as it is unspooled. The mud motor 715 may be powered by the pumping fluid. To enable the fluid to pass through the mud motor 715, a conduit through the fiber spool 712 and the neutral buoyancy float 717 may allow some of the fluid to exit to a fluid volume below the fiber spooler mechanism 710. For example, 10% to 50% of fluid flow may pass through the mud motor 715, while a remainder of the flow moves a conveyance vehicle 700 downhole. Other fluid ratios may be used.

The fiber spooler mechanism 710 may be first mounted in a spooler launcher 718. The spooler launcher 718 may be used to insert the fiber spooler 710 in the production string 713. The optical fiber cable 730 may be anchored at the surface by mounting an end of the optical fiber cable 730 to a well head exit 711. When pumping begins, the fiber spooler 710 may start to move downhole while at the same time the mud motor 715 rotates the fiber spool 712. This action causes the optical fiber cable 730 to be unwound in a spiral fashion against an inner wall of the pipe of the production string 713. In some implementations, a uniform spiral of the fiber spooler 710 may be created by fixing a rotational velocity and linear deployment velocity via constant flow through the mud motor 715. It may also be possible to deploy the optical fiber 730 with minimum rotation and/or without the mud motor 715 so that a length of the optical fiber 730 deployed in the well 703 is equal to or near equal to the depth of the well 703.

The fiber spooler 710 may continue to unwind the optical fiber 730 until it reaches the end of the well 703 (the toe). In some implementations, a catcher 720 (which may be optional) locks on to the end of the fiber spooler 710 to prevent further movement. The catcher 720 may also lock the mud motor 715 to prevent further rotation. In some implementations, the deployment of the conveyance vehicle 700 into the well 703 may be automatic. After the optical fiber 730 is laid with the arrival of the fiber spooler 710 at the end of the well 703, the fiber spooler 710 may not be retrieved. In some implementations, the catcher 720 may be deployed with casing, with coiled tubing, or may be pumped down the well 703 and subsequently pressure-activated.

Alternative implementations may include a metal or composite tube housing a coil of the optical fiber 730, where the fiber un-wraps from the coil as the conveyance vehicle 700 propagates along the wellbore. Flexible cups may be used exterior to the tube or in front of the tube in order to enable pumped deployment. The assembly may be gravity assisted with reduced fluid pumping in vertical or largely vertical sections where gravity enables propagation along the wellbore. Fluid pumping may commence in order to deploy the optical fiber 730 in a horizontal section of the well 703 once the gravity assisted propagation ceases.

In some implementations, the optical fiber cable 730 may include a fiber optic pressure gauge 722 located in the conveyance vehicle 700 and/or other sensors like e.g. a 3-axis seismic sensor like a geophone or accelerometer. A seismic 3-axis sensor may be used to determine the direction/location of a microseismic event and constrain the initial solution space for locating events in 3D using DAS systems. The core of the optical fiber 730 or one of the cores of the optical fiber 730 (if the optical fiber 730 is a multi-core optical fiber) may be used to communicate information to the surface with respect to the pressure readings generated by the fiber optic pressure gauge 722. As shown in FIG. 7A, the optical fiber 730 may be spliced or coupled to a surface optical fiber cable 714 connected to surface instrumentation 716.

FIG. 7B is a schematic representation depicting the optical fiber 730 deployed by the pump down spooler fiber deployment of FIG. 7A. The optical fiber 730 is coupled to the fiber spooler 710 that has been captured by the catcher 720 and runs in a spiral in the production string 713 in the well 703 to the well head exit 711 at the surface. The surface optical cable 714 couples the optical fiber 730 from the well head exit 711 to surface instrumentation 716 that may include an interrogator. The interrogator may include an optical source that generates an optical signal in the optical fiber 730 to the end of the optical fiber 730 at the captured fiber spooler 710, a receiver to receive an optical signal or signals in response to the interrogation signal from the optical source, and processing equipment to process the received optical signal(s). In some implementations, the processing equipment may comprise a computer. In some implementations, the computer may be configured to operate and deploy the conveyance vehicles 700 and 750.

In some implementations, received optical signal(s) by the surface instrumentation 716 may include data from the pressure gauge 722 and/or data from the optical fiber 730. The processing equipment of the interrogator of the surface instrumentation 716 may include one or more interferometric systems. The processing may be performed using one or more techniques as previously discussed or using other techniques of processing data from sensors associated with one or more optical fibers.

In some implementations, other types of fiber optic sensors may be deployed by the conveyance vehicles 700, 750. These alternative fiber optic sensors may also be used in instrumented wells such as the instrumented well 105. These fiber optic sensors may be used in detecting microseismic events such as those depicted in FIG. 5A. In some implementations, the fiber optic sensors may include point sensors either at the surface and/or down-hole. Single point or multi-point pressure/temperature sensors are commonly used in reservoir monitoring applications, where the pressure sensors may be capable of collecting data at rates up to 2,000 Hertz (Hz) or higher.

Fiber optic cables, such as those used in FIGS. 1 and 5A, and described by the optical fiber cable 730, may house one or several optical fibers and the optical fibers may be single mode fibers, multi-mode fibers or a combination of single mode and multi-mode optical fibers. In some implementations, the optical fiber cable 730 may be coupled to a computer and/or to the surface instrumentation 716 of FIGS. 7A-7B to form an optical fiber sensing system. The fiber optic sensing systems connected to the optical fiber(s) 730 may include Distributed Temperature Sensing (DTS) systems, Distributed Acoustic Sensing (DAS) Systems, Distributed Strain Sensing (DSS) Systems, quasi-distributed sensing systems where multiple single point sensors are distributed along the optical fiber and/or optical fiber cable 730, or single point sensing systems where the sensors are located at the end of the optical fiber cable 730.

In some implementations, the optical fiber 730 and optical fiber cables used within the instrumented well(s) 105 may also be used in conjunction with Optical Time Domain Reflectometry (OTDR) and/or Optical Frequency Domain Reflectometry (OFDR) based Distributed Fiber Optic Sensing systems. True Distributed Fiber Optic Sensing (DFOS) systems may operate based on e.g. Optical Time Domain Reflectometry (OTDR) principles or Optical Frequency Domain Reflectometry (OFDR). OTDR based systems are pulsed where one or more optical pulses may be transmitted down an optical fiber and backscattered light (Rayleigh, Brillouin, Raman etc.) is measured and processed. Time of flight for the optical pulse(s) indicate where along the optical fiber the measurement is done. OFDR based systems operate in continuous wave (CW) mode where a tunable laser is swept across a wavelength range, and the back scattered light is collected and processed.

Fiber optic sensing systems may operate using various sensing principles in their detection of subsurface properties and seismic events. For example, the optical fiber cable 730 may use principles such as Rayleigh scattering, Brillouin scattering, Raman scattering (including but not limited to amplitude based sensing systems like e.g. DTS systems based on Raman scattering), phase sensing based systems (such as, for example, DAS systems based on interferometric sensing using e.g. homodyne or heterodyne techniques where the system may sense phase or intensity changes due to constructive or destructive interference), strain sensing systems (such as Distributed Strain Sensing (DSS) systems using dynamic strain measurements based on interferometric sensors or static strain sensing measurements), etc. In some implementations, fiber optic sensing system formed by the optical fiber cable 730, surface instrumentation 716, and computer (described within additional detail in FIG. 8) may also utilize DSS systems using Brillouin scattering and quasi-distributed sensors based on Fiber Bragg Gratings (FBGs) where a wavelength shift is detected. Multiple FBGs may be used to form Fabry-Perot type interferometric sensors for phase or intensity-based sensing. Single point fiber optic sensors based on Fabry-Perot or FBG or intensity based sensors may also be utilized to detect seismic events.

In some implementations, the optical fiber 730 may be configured to detect microseismic events, the collected data used to generate an optical solution. In other implementations, various hybrid approaches (e.g., electrical/optical systems) may be used to generate hybrid solutions. For example, single point or quasi-distributed or distributed fiber optic sensors may be configured for mixed use with electrical sensors in instrumented wells. In the hybrid configuration, the optical fiber cable 730 may include an optical fiber and one or more electrical conductors. In other implementations the downhole sensors may be fiber optic sensors capable of seismic sensing and surface sensors may be electrical sensors capable of seismic sensing using e.g. 3-axis geophones. Electrical sensors may include pressure sensors based on quartz type sensors or strain gauge based sensors or other commonly used sensing technologies. Pressure sensors, optical or electrical, may be housed in dedicated gauge mandrels or attached outside the casing in various configurations for down-hole deployment or deployed conventionally at the surface well head or flow lines. For example, the fiber optic pressure gauge 722 may be used in combination with the optical fiber 730 for event monitoring.

### Example Computer

FIG. 8 is a block diagram depicting an example computer, according to some implementations. A computer 800 includes a processor 801 (possibly including multiple processors, multiple cores, multiple nodes, and/or implementing multi-threading, etc.). The computer 800 includes memory 807. The memory 807 may be system memory or any one or more of the above already described possible realizations of machine-readable media. The computer 800 also includes a bus 803 and a network interface 805. The computer 800 may communicate via transmissions to and/or from remote devices via the network interface 805 in accordance with a network protocol corresponding to the type of network interface, whether wired or wireless and depending upon the carrying medium. In addition, a communication or transmission may involve other layers of a communication protocol and or communication protocol suites (e.g., transmission control protocol, Internet Protocol, user datagram protocol, virtual private network protocols, etc.).

The computer 800 also includes a microseismic event locator 811 and an optical fiber controller 815 which may perform the operations described herein. For example, the microseismic event locator 811 may be configured to model wave paths through a subsurface model and determine the apparent location of seismic events for individual sensor arrays based on modeled traveled times that closest match picked P and S wave travel times. In some implementations, the microseismic event locator 811 also may substitute the modeled travel times for picked travel times on both a primary seismic event of interest and a neighboring seismic event (detected by a second sensor array). The microseismic event locator 811 may compute, based on the modeled travel times of the primary event and the neighboring event in time, a multi-array 3D Geiger final solution to locate the primary seismic event location detected by the first sensor array (Array 510). The microseismic event locator 811 may be configured to perform any of the operations and processes described with reference to FIGS. 2-5C.

In some implementations, the optical fiber controller 815 may be configured to perform the operations described with reference to FIGS. 1 and 6-8. For example, the optical fiber controller 815 may be communicatively coupled to one or more surface instrumentation 716 units configured to send and/or receive signals via the optical fiber 730 in each instrumented well 105. In some implementations, the computer 800 may be located proximate to the instrumented well(s) 105, although other suitable locations for the computer 800 may be possible. For example, the computer 800 may include one or more computing devices or systems located at the treatment well 103, at the instrumented well 105, or in other locations. The computer 800, and one or more sub-components, may be located apart from the other components shown in FIG. 1. For example, the computer 800 may be located at a data processing center, a computing facility, and other suitable locations.

In other implementations, data collection from the instrumented wells 105 may be done using autonomous DAS systems coupled to the optical fiber controller 815. Autonomous DAS systems may enable event detection and processing to occur in real-time. For example, microseismic events detected by an autonomous DAS system in an instrumented well 105 may be sent (with related data) to a cloud domain for near real-time processing. The automated system may use one stand-alone sub-system per well to interrogate the optical fiber and do strain and/or microseismic event detection in real-time (e.g., the surface instrumentation 716), and this information may be sent to the computer 800 off-site. Data from multiple instrumented wells 105 may be streamed using wireless cell phone technology and/or satellite communication to transfer data to a cloud location or a central location where data from multiple fibers/locations may be processed to produce actionable results that may be streamed back to the location.

The optical fiber controller 815 may be communicatively coupled to the processor 801 via the bus 803. The optical fiber controller 815 may analyze microseismic data from a fracture treatment of the subsurface zone 101. Microseismic data from a fracture treatment may include data collected before, during, and after fluid injection. The optical fiber controller 815 may receive the microseismic data at any suitable time. In some instances, the optical fiber controller 815 receives the microseismic data in real time (or substantially in real time) during the fracture treatment. For example, the microseismic data may be sent to the optical fiber controller 815 immediately upon detection by a DAS system within the instrumented well 105. In some implementations, the optical fiber controller 815 receives some or all of the microseismic data after a fracture treatment has been completed. The optical fiber controller 815 may communicate the received data to the microseismic event locator 811 for additional analyses.

The optical fiber controller 815 may receive the microseismic data in various suitable formats. For example, the optical fiber controller 815 may receive the microseismic data in a format produced by microseismic sensors or detectors, or the optical fiber controller 815 may receive the microseismic data after the data has been formatted, packaged, or otherwise processed. The optical fiber controller 815 may receive the microseismic data by any suitable means. For example, the optical fiber controller 815 may receive the microseismic data by a wired or wireless communication link, by a wired or wireless network, or by one or more disks or other tangible media.

Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Second Flowchart of Example Operations

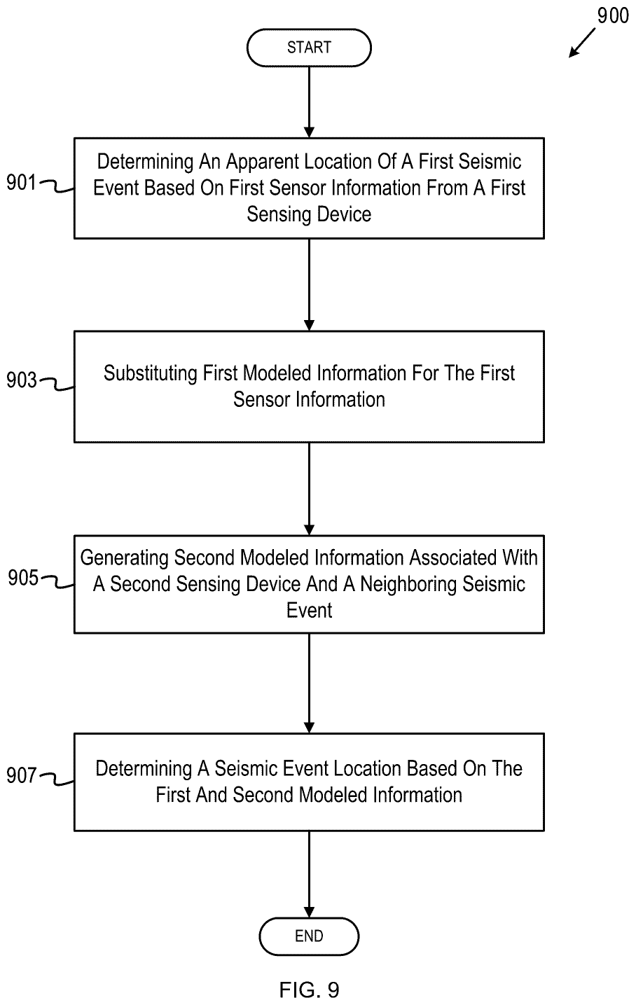

FIG. 9 is a flowchart depicting example operations for determining seismic event locations that are detected by only one sensor array, according to some implementations. Operations of a method 900 may be performed by software, firmware, hardware, or a combination thereof. Such operations are described with reference to FIGS. 4 and 5A-5C. However, such operations may be performed by other systems or components. The operations of the method 900 begin at block 901. The operations of the method may be performed by the computer system 800 or any other suitable computerized components.

At block 901, the method 900 includes determining an apparent location of a first seismic event based on first sensing information from a first sensing device. For example, the apparent location of the seismic event 507 may be determined via modeling through a 3D subsurface model based on sensing information obtained from a DAS system within an instrumented well 105. The apparent location may be a grid location within the subsurface model one or more modeled travel times (i.e., arrival times) match the picked P-wave and S-wave travel times of event 507. In some implementations, the method 900 may be used to detect and process other subsurface events (e.g., non-seismic events). Flow progresses to block 903.

At block 903, the method 900 includes substituting the first modeled information for the first sensor information. For example, the microseismic event locator 811 may substitute modeled travel times of the event 567 for the picked travel times of event 507. Flow progresses to block 905.

At block 905, the method 900 includes generating second modeled information associated with a second sensing device and a neighboring seismic event. For example, the microseismic event locator 811 may model arrival times for a neighboring event 509 that occurs within a time window or proximity of the event 507. It may be assumed that neighboring events such as event 509 may arise from the same subsurface change that induced the event 507. The microseismic event locator 811 may independently determine an apparent location of the event 507 and the neighboring event 509. Flow progresses to block 907.

At block 907, the method 900 includes determining a seismic event location based on the first and second modeled information. For example, modeled travel times of events 567, 569 may be substituted for the picked travel times of events 507, 509. Events 567, 569 may be matched, and the modeled travel times may be used to determine a true seismic event location of the event 507 detected by Array 510. In some implementations, the true location of the seismic event may be determined as a multi-array 3D Geiger final solution. In other implementations, other methods of triangulation may be possible. For example, an image-based solution of the location of the microseismic event may be determined. Flow of the method 900 ceases.

### Example Hydraulic Fracturing System

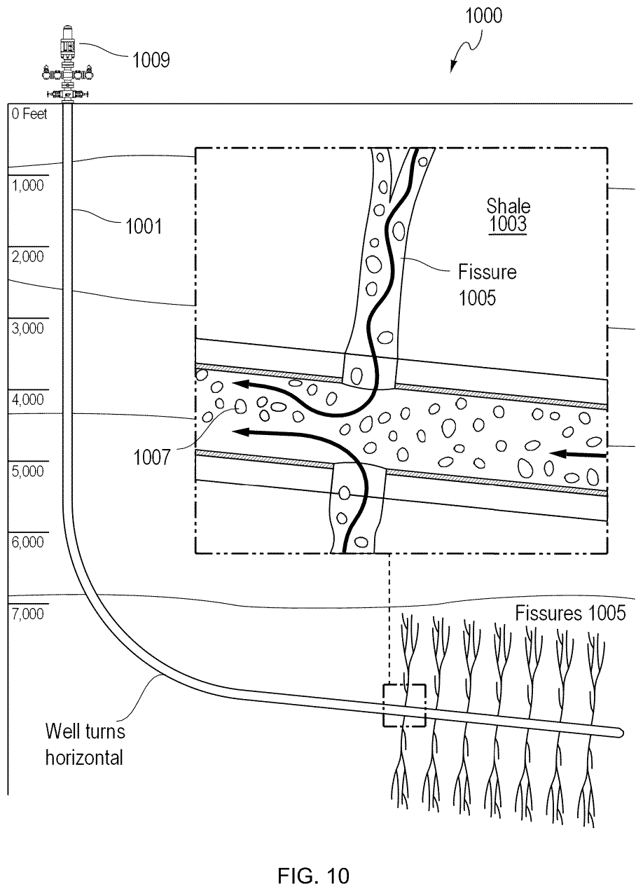

FIG. 10 is an illustration of an example hydraulic fracturing operation in a shale formation, according to some implementations. A well system 1000 includes a well 1001, a shale formation 1003, one or more fissures 1005, proppant 1007, and surface equipment 1009. The well 1001 may extend from a surface location down into a shale formation 1003. In some implementations, well system 1000 is a treatment well, whereby the surface equipment 1009 is communicatively coupled with well 1001. In some implementations, the surface equipment 1009 may include a wellhead. In other implementations, the surface equipment 1009 may also include one or more hydraulic fracturing pumps coupled to one or more hydraulic fracturing fluid sources (not shown) for hydraulic fracturing operations in the well 1001. In other implementations, the surface equipment 1009 may also include one or more pumps coupled to one or more fluid sources (not shown) for injection of treatment fluids such as chemicals into well 1001 for a particular treatment operation, such as acidizing. In some implementations, the well 1001 may be similar to the treatment well 103 of FIG. 1.

In some implementations, a treatment within the well 1001 may include a fracture treatment to initiate, propagate, or open one or more fissures 1005 in the shale formation 1003. The fracture treatment may include a mini fracture test treatment, a regular or full fracture treatment, a follow-on fracture treatment, a re-fracture treatment, a final fracture treatment, and other fracture treatments. The fracture treatment may pump an injection fluid into, or pump out an injection fluid out of, the fissures 1005 at any suitable fluid pressure and fluid flow rate. Injection fluids may be pumped above, at, or below a fracture initiation pressure, above, at, or below a fracture closure pressure, or at other suitable combinations of these and other injection fluid pressures. The one or more fissures may be kept open by a proppant 1007. In some implementations, the proppant 1007 may be sand or a ceramic, although other proppants may be used.

The above-described fracture treatment, as well as other activities and natural phenomena within the well 1001, may generate microseismic events within, proximate to, or outside the example shale formation 1003. However, microseismic events may be generated within any type of subsurface formation. Microseismic data may be collected from the shale formation 1003. For example, the microseismic data may be collected by an acoustic sensing cable inserted in the well 1001. The microseismic information detected by the acoustic sensing cable may include acoustic/seismic waves generated by natural phenomena, acoustic/seismic waves associated with a fracture treatment applied through the well 1001, or other seismic waves. For example, the acoustic sensing cable may detect acoustic/seismic waves generated by rock slips, rock movements, rock fractures, and other snap, crackle, and pop events in the subsurface. Microseismic events in the subsurface zone may occur, for example, along or near induced hydraulic fractures, such as the fissures 1005. The microseismic events may be associated with pre-existing natural fractures or hydraulic fracture planes.

A well system controller may be included as part of the surface equipment 1009. In some implementations, the well system controller may include an acoustic sensing controller similar to the optical fiber controller 815 of FIG. 8. The acoustic sensing controller may be communicatively and optically coupled to the acoustic sensing cable in the well 1001. In some implementations, only a single acoustic sensing cable may be positioned within the well 1001. However, other multiple acoustic sensing cables and/or cores may be used. In some implementations, the acoustic sensing cable may be located in a portion of the well 1001. In other implementations, the acoustic sensing cable may be disposed along the entire length of well 1001.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

### Example Implementations

Implementation 1: A method for determining a seismic event location of a first seismic event, the method comprising: determining an apparent location of the first seismic event based on first sensor information from a first sensing device; substituting first modeled information for the first sensor information; generating second modeled information associated with a second sensing device and a neighboring seismic event; and determining the seismic event location based on the first and second modeled information.

Implementation 2: The method of the Implementation 1, further comprising: detecting, via the first sensing device, P-wave and S-wave arrival times of the first seismic event.

Implementation 3: The method of any one or more of the Implementations 1-2, further comprising: modeling, within a 3D subsurface model comprising a plurality of formation layers, the first modeled information including a first travel time between the apparent location of the first seismic event and the first sensing device; and modeling, within the 3D subsurface model, the second modeled information associated with the second sensing device and the neighboring seismic event, wherein the second modeled information constrains the seismic event location.

Implementation 4: The method of any one or more of the Implementations 1-3, further comprising: matching the second modeled information associated with the second sensing device and the neighboring seismic event with the first modeled information associated with the first sensing device and the first seismic event.

Implementation 5: The method of any one or more of the Implementations 1-4, wherein determining the seismic event location based on the first and second modeled information comprises performing a multi-array 3D Geiger final solution using the first modeled information and the second modeled information.

Implementation 6: The method of any one or more of the Implementations 1-5, further comprising: adjusting a subsurface operation based, at least in part, on the determined seismic event location.

Implementation 7: The method of any one or more of the Implementations 1-6, wherein the neighboring seismic event is an event within a time proximity of the first seismic event.

Implementation 8: A system configured to determine a seismic event location of a first seismic event, the system comprising: A first sensing device positioned in a first well; A second sensing device positioned in a second well; a processor; and a computer-readable medium having instructions executable by the processor, the instructions including: instructions to determine an apparent location of the first seismic event based on first sensor information from the first sensing device; instructions to substitute first modeled information for the first sensor information; instructions to generate second modeled information associated with the second sensing device and a neighboring seismic event; and instructions to determine the seismic event location based on the first and second modeled information.

Implementation 9: The system of the Implementation 8, further comprising: instructions to detect, via the first sensing device, P-wave and S-wave arrival times of the first seismic event.

Implementation 10: The system of any one or more of the Implementations 8-9, further comprising: instructions to model, within a 3D subsurface model comprising a plurality of formation layers, the first modeled information including a first travel time between the apparent location of the first seismic event and the first sensing device; and instructions to model, within the 3D subsurface model, the second modeled information associated with the second sensing device and the neighboring seismic event, wherein the second modeled information constrains the seismic event location.

Implementation 11: The system of any one or more of the Implementations 8-10, further comprising: instructions to match the second modeled information associated with the second sensing device and the neighboring seismic event with the first modeled information associated with the first sensing device and the first seismic event.

Implementation 12: The system of any one or more of the Implementations 8-11, wherein the instructions to determine the seismic event location based on the first and second modeled information comprise instruction to perform a multi-array 3D Geiger final solution using the first modeled information and the second modeled information.

Implementation 13: The system of any one or more of the Implementations 8-12, further comprising: adjusting a subsurface operation based, at least in part, on the determined seismic event location.

Implementation 14: The system of any one or more of the Implementations 8-13, wherein the neighboring seismic event is an event within a time proximity of the first seismic event.

Implementation 15: One or more non-transitory machine-readable media including instructions executable by a processor to cause the processor to determine a seismic event location of a first seismic event, the instructions comprising: instructions to determine an apparent location of the first seismic event based on first sensor information from a first sensing device; instructions to substitute first modeled information for the first sensor information; instructions to generate second modeled information associated with a second sensing device and a neighboring seismic event; and instructions to determine the seismic event location based on the first and second modeled information.

Implementation 16: The machine-readable media of the Implementation 15, further comprising: instructions to model, within a 3D subsurface model comprising a plurality of formation layers, the first modeled information including a first travel time between the apparent location of the first seismic event and the first sensing device; and instructions to model, within the 3D subsurface model, the second modeled information associated with the second sensing device and the neighboring seismic event, wherein the second modeled information constrains the seismic event location.

Implementation 17: The machine-readable media of any one or more of the Implementations 15-16, further comprising: instructions to match the second modeled information associated with the second sensing device and the neighboring seismic event with the first modeled information associated with the first sensing device and the first seismic event.

Implementation 18: The machine-readable media of any one or more of the Implementations 15-17, wherein the instructions to determine the seismic event location based on the first and second modeled information comprise instruction to perform a multi-array 3D Geiger final solution using the first modeled information and the second modeled information.

Implementation 19: The machine-readable media of any one or more of the Implementations 15-18, further comprising: adjusting a subsurface operation based, at least in part, on the determined seismic event location.

Implementation 20: The machine-readable media of any one or more of the Implementations 15-19, wherein the neighboring seismic event is an event within a time proximity of the first seismic event.

What is claimed is:

1. A method for determining a seismic event location of a first seismic event, the method comprising:
determining an apparent location of the first seismic event based on first sensor information from a first sensing device;
substituting first modeled information for the first sensor information;
generating second modeled information associated with a second sensing device and a neighboring seismic event; and
determining the seismic event location based on the first and second modeled information.

2. The method of claim 1, further comprising:
detecting, via the first sensing device, P-wave and S-wave arrival times of the first seismic event.

3. The method of claim 1, further comprising:
modeling, within a 3D subsurface model comprising a plurality of formation layers, the first modeled information including a first travel time between the apparent location of the first seismic event and the first sensing device; and
modeling, within the 3D subsurface model, the second modeled information associated with the second sensing device and the neighboring seismic event, wherein the second modeled information constrains the seismic event location.

4. The method of claim 1, further comprising:
matching the second modeled information associated with the second sensing device and the neighboring seismic event with the first modeled information associated with the first sensing device and the first seismic event.

5. The method of claim 1, wherein determining the seismic event location based on the first and second modeled information comprises performing a multi-array 3D Geiger final solution using the first modeled information and the second modeled information.

6. The method of claim 1, further comprising:
adjusting a subsurface operation based, at least in part, on the determined seismic event location.

7. The method of claim 1, wherein the neighboring seismic event is an event within a time proximity of the first seismic event.

8. A system configured to determine a seismic event location of a first seismic event, the system comprising:
A first sensing device positioned in a first well;
A second sensing device positioned in a second well;
a processor; and
a computer-readable medium having instructions executable by the processor, the instructions including:
instructions to determine an apparent location of the first seismic event based on first sensor information from the first sensing device;
instructions to substitute first modeled information for the first sensor information;
instructions to generate second modeled information associated with the second sensing device and a neighboring seismic event; and
instructions to determine the seismic event location based on the first and second modeled information.

9. The system of claim 8, further comprising:
instructions to detect, via the first sensing device, P-wave and S-wave arrival times of the first seismic event.

10. The system of claim 8, further comprising:
instructions to model, within a 3D subsurface model comprising a plurality of formation layers, the first modeled information including a first travel time between the apparent location of the first seismic event and the first sensing device; and
instructions to model, within the 3D subsurface model, the second modeled information associated with the second sensing device and the neighboring seismic event, wherein the second modeled information constrains the seismic event location.

11. The system of claim 8, further comprising:
instructions to match the second modeled information associated with the second sensing device and the neighboring seismic event with the first modeled information associated with the first sensing device and the first seismic event.

12. The system of claim 8, wherein the instructions to determine the seismic event location based on the first and second modeled information comprise instruction to perform a multi-array 3D Geiger final solution using the first modeled information and the second modeled information.

13. The system of claim 8, further comprising:
adjusting a subsurface operation based, at least in part, on the determined seismic event location.

14. The system of claim 8, wherein the neighboring seismic event is an event within a time proximity of the first seismic event.

15. One or more non-transitory machine-readable media including instructions executable by a processor to cause the processor to determine a seismic event location of a first seismic event, the instructions comprising:
instructions to determine an apparent location of the first seismic event based on first sensor information from a first sensing device;
instructions to substitute first modeled information for the first sensor information;
instructions to generate second modeled information associated with a second sensing device and a neighboring seismic event; and
instructions to determine the seismic event location based on the first and second modeled information.

16. The machine-readable media of claim 15, further comprising:
instructions to model, within a 3D subsurface model comprising a plurality of formation layers, the first modeled information including a first travel time between the apparent location of the first seismic event and the first sensing device; and
instructions to model, within the 3D subsurface model, the second modeled information associated with the second sensing device and the neighboring seismic event, wherein the second modeled information constrains the seismic event location.

17. The machine-readable media of claim 15, further comprising:
instructions to match the second modeled information associated with the second sensing device and the neighboring seismic event with the first modeled information associated with the first sensing device and the first seismic event.

18. The machine-readable media of claim 15, wherein the instructions to determine the seismic event location based on the first and second modeled information comprise instruction to perform a multi-array 3D Geiger final solution using the first modeled information and the second modeled information.

19. The machine-readable media of claim 15, further comprising:
adjusting a subsurface operation based, at least in part, on the determined seismic event location.

20. The machine-readable media of claim 15, wherein the neighboring seismic event is an event within a time proximity of the first seismic event.
